(19) United States
(12) Patent Application Publication
(10) Pub. No.: US 2014/0201101 A1
(43) Pub. Date: Jul. 17, 2014

(54) Method and system for managing a service agreement business

(71) Applicant: Jay Edward Morrison, Houston, TX (US)

(72) Inventor: Jay Edward Morrison, Houston, TX (US)

(21) Appl. No.: 11/151,869

(22) Filed: Jun. 13, 2005

(51) Int. Cl. G06Q 10/10

(52) U.S. Cl. CPC G06Q 10/10
USPC 705/342

(57) ABSTRACT

A method and system for managing a service agreement business. First data is received from a first party and second data is received from a second party, wherein the first party and the second party are in a business relationship for providing service according to a service agreement to a customer. The first data and the second data are automatically integrated to generate a combined data pool that is understandable to both the first party and the second party. In response to receiving a request for a report from at least one of the first party, the second party and the customer, a report is generated based on the request and the combined data pool, wherein the request identifies how data of the combined data pool is sorted such that the report facilitates management of the service agreement.

### FIELD OF INVENTION

The present invention relates to the field of service agreements. Specifically, the present invention relates to a method and system for managing a service agreement business.

### BACKGROUND OF THE INVENTION

Service agreements are agreements whereby a service provider agrees to provide a service to an end customer. For example, an organization may enter into a service agreement with a hardware manufacturer to maintain and provide support for that hardware. Often, a hardware manufacturer is not in the business of selling electronic devices to an end user. Rather, a reseller having a business partner relationship with the manufacturer sells these devices. In addition to selling hardware, the reseller may sell service agreements on behalf of the manufacturer or in conjunction with the manufacturer. In this way, the end user contracts with the manufacturer or jointly to provide support for the purchased hardware.

In order to provide appropriate support and service to the end user, it is necessary to manage and maintain these service agreements. Currently, the management of service agreements is problematic for the device resellers, as well as for the manufacturers who rely on the device resellers to maintain these service agreements. For example, device resellers typically employ salespeople to work with the end users to maintain the service agreements. Typically, these salespeople are not provided with the information necessary for proper maintenance of service agreements, as the information the reseller has about service agreements is typically incomplete or inaccurate. For example, some end users have different divisions for buying products and for maintaining these products. Moreover, some end users use different names under one business entity. Different resellers also use different naming conventions, thus creating issues when services agreements are taken over by a different seller. This information is typically not available to the sales force, thus requiring salespeople to chase individual service agreements. Moreover, due to the large volume of service agreements typically sold by resellers, this task is increasingly cumbersome to the business partners.

Currently, service agreements are typically managed using monthly batch reports. Due to the time taken to compile these reports, they are often out-of-date by the time a salesperson or a customer receives them, reducing their effectiveness. In particular, because there are currently no effective solutions for managing a service agreement business, it is often very difficult to maintain all service agreements, thus causing many service agreements to lapse, or not fully renew, at a disservice to the manufacturer, the reseller and the end user.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system platform upon which embodiments of the present invention may be practiced.

FIG. 2 is a block diagram of one embodiment of a computer system network upon which the present invention may be practiced.

FIG. 3 illustrates a system for managing a service agreement, in accordance with an embodiment of the present invention.

FIG. 4 illustrates a system for managing a service agreement, in accordance with another embodiment of the present invention.

FIG. 5 is a flowchart diagram illustrating steps of a process for managing a service agreement, in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

Various embodiments of the present invention, a method and system for managing a service agreement business, are described herein. First data is received from a first party and second data is received from a second party, wherein the first party and the second party are in a business relationship for providing service according to a service agreement to a customer. The first data and the second data are automatically integrated to generate a combined data pool that is understandable to both the first party and the second party. In response to receiving a request for a report from at least one of the first party, the second party and the customer, a report is generated based on the request and the combined data pool, wherein the request identifies how data of the combined data pool is sorted such that the report facilitates management of the service agreement. The described invention provides for optimizing the management of a service agreement business by integrating the information known by the separate parties.

### Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here and generally conceived to be a self-consistent sequence of steps of instructions leading to a desired result. The steps are those requiring physical manipulations of data representing physical quantities to achieve tangible and useful results. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving”, “integrating”, “generating”, “segmenting”, “filtering”, “placing”, “determining”, “comparing”, “translating”, or the like, refer to the actions and processes of a computer system or similar electronic computing device. The computer system or similar electronic device manipulates and transforms data represented as electronic quantities within the computer system's registers and memories into other data similarly represented as physical quantities within the computer system memories into other data similarly represented as physical quantities within the computer system memories or registers or other such information storage, transmission, or display devices.

### Exemplary Hardware Upon which Embodiments of the Present Invention may be Implemented

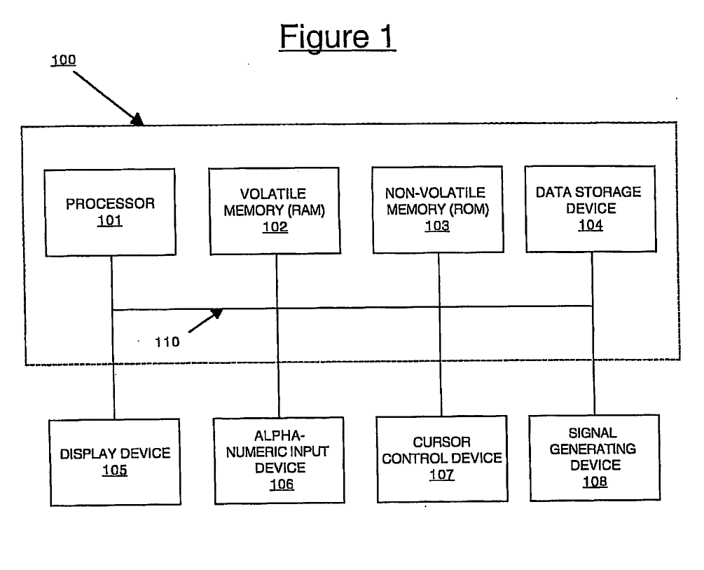

Refer now to FIG. 1 which illustrates an exemplary computer system 100 upon which embodiments of the present invention may be practiced. In general, computer system 100 comprises bus 110 for communicating information, processor 101 coupled with bus 110 for processing information and instructions, random access (volatile) memory (RAM) 102 coupled with bus 110 for storing information and instructions for processor 101, read-only (non-volatile) memory (ROM) 103 coupled with bus 110 for storing static information and instructions for processor 101, data storage device 104 such as a magnetic or optical disk and disk drive coupled with bus 110 for storing information and instructions.

In one embodiment, computer system 100 comprises an optional user output device such as display device 105 coupled to bus 110 for displaying information to the computer user, an optional user input device such as alphanumeric input device 106 including alphanumeric and function keys coupled to bus 110 for communicating information and command selections to processor 101, and an optional user input device such as cursor control device 107 coupled to bus 110 for communicating user input information and command selections to processor 101. Furthermore, an optional input/output (I/O) device 108 is used to couple computer system 100 onto, for example, a network.

Display device 105 utilized with computer system 100 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

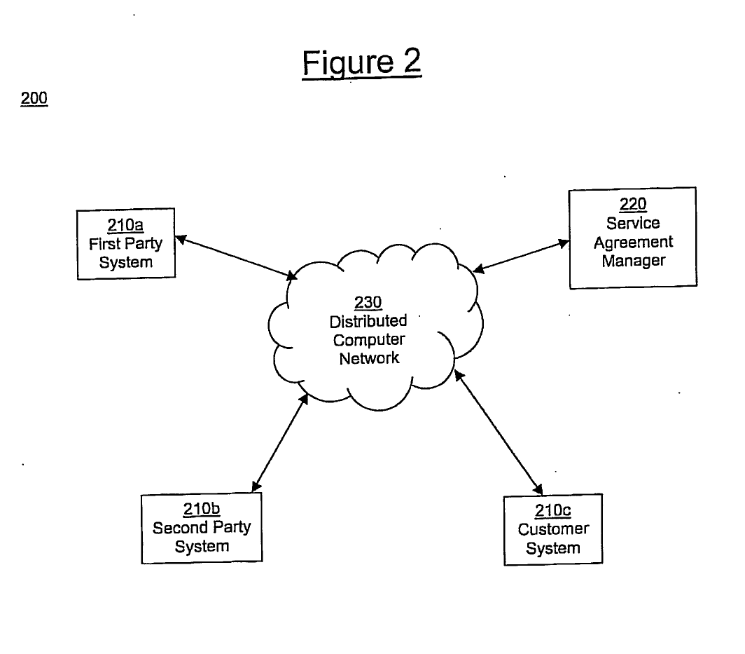

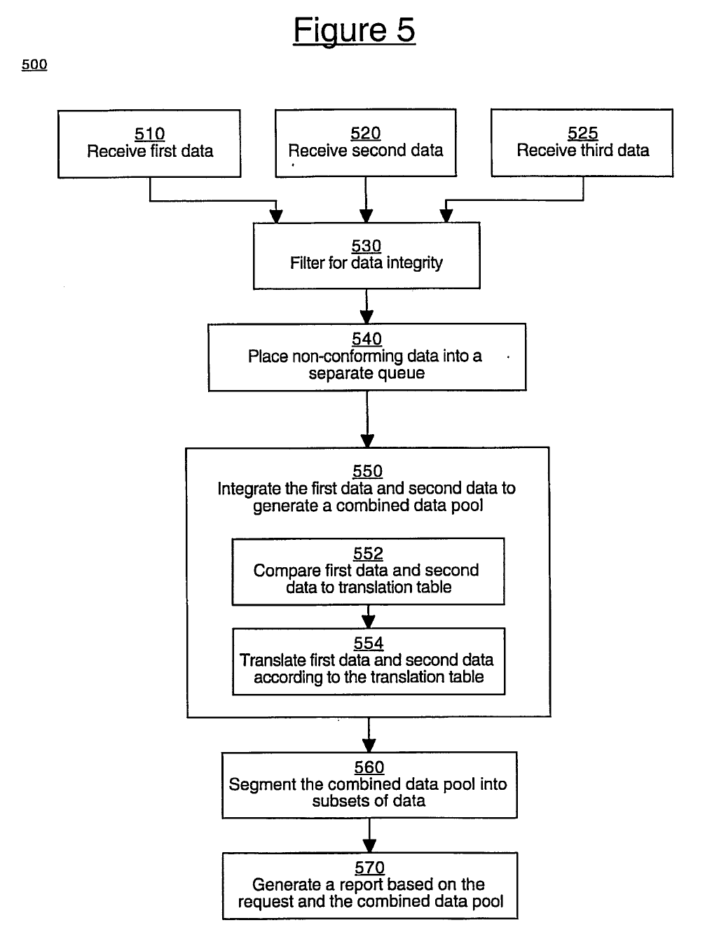

Referring now to FIG. 2, a block diagram of a computer system network 200 upon which the present invention may be practiced is shown. As depicted in FIG. 2, system 200 comprises a plurality of client systems: first party system 210a, second party system 210b, and customer system 210c. The client systems are communicatively coupled to service agreement manager 220 via a distributed computer network 230. In one embodiment, client systems 210a-c communicate with service agreement manager 220 to access information regarding service agreements. In one embodiment, service agreement manager 220 performs a method for managing a service agreement business (e.g., process 500 of FIG. 5). Client systems 210a-c communicate with service agreement manager 220 via the communications protocols of distributed computer network 230, hereafter referred to as network 230. It should be appreciated that client systems 210a-c can comprise any number or combination of electronic devices, systems or networks, including but not limited to: desktop computer systems, laptop computer systems, handheld computer systems, or any electronic device capable of communicating over a network.

Referring still to FIG. 2, network 230 includes well know network technologies. For example, network 230 can be implemented using LAN technologies (e.g., Ethernet, Tokenring, wireless, etc.), the Internet, or other wired or wireless network technologies. The communications links between service agreement manager 220, client systems 210a-c and network 230 can be implemented using, for example, a telephone circuit, communications cable, optical cable, wireless link, or the like.

### A Method and System for Managing a Service Agreement Business

Various embodiments of the present invention, a method and system for managing a service agreement business, are described herein. First data is received from a first party and second data is received from a second party, wherein the first party and the second party are in a business relationship for providing service according to a service agreement to a customer. In one embodiment, the first party is a service provider for providing service to the customer according to the service agreement and the second party is a reseller of the service agreement for reselling the service agreement to the customer. In some cases a third party may also be involved. The third party is a distributor who resides between the first and second party. In one embodiment, the service agreement comprises a contractual relationship between the customer and the first party such that the first party provides service on at least one electronic device used by the customer.

In one embodiment, at least one of the first data and the second data is filtered for data integrity. If a data item of at least one of the first data and the second data is not in conformance with the data integrity, the data item is placed in a separate queue apart from the combined data pool. In one embodiment, it is determined whether a portion of the data item includes duplicate information with respect to a second data item such that if the data item includes duplicate information with respect to a second data item, it is determined that the data item is not in conformance with the data integrity. In one embodiment, it is determined whether a portion of the data item includes unrecognizable information such that if the data item includes unrecognizable information, it is determined that the data item is not in conformance with the data integrity.

The first data and the second data are automatically integrated to generate a combined data pool that is understandable to both the first party and the second party. In one embodiment, the combined data pool is understandable to the third party also. In one embodiment, the combined data pool is automatically segmented into subsets of data based on predetermined categories. In one embodiment, the first data and the second data are compared to at least one translation table, wherein the translation table is for transforming the first data such that it is understandable to the second party, and the third partner where applicable, and the customer and for transforming the second data such that it is understandable to the first party and the customer. The first data and the second table are translated according to the translation table to generate the combined data pool.

In response to receiving a request for a report from at least one of the first party, the second party, the third party when applicable, and the customer, a report is generated based on the request and the combined data pool, wherein the request identifies how data of the combined data pool is sorted such that the report facilitates management of the service agreement. In one embodiment, the report is outputted to a spreadsheet. In another embodiment, the report is outputted to an enterprise management system. In another embodiment, the report is an electronic database which can be electronically transmitted from the first party, the second party or the third party to the customer.

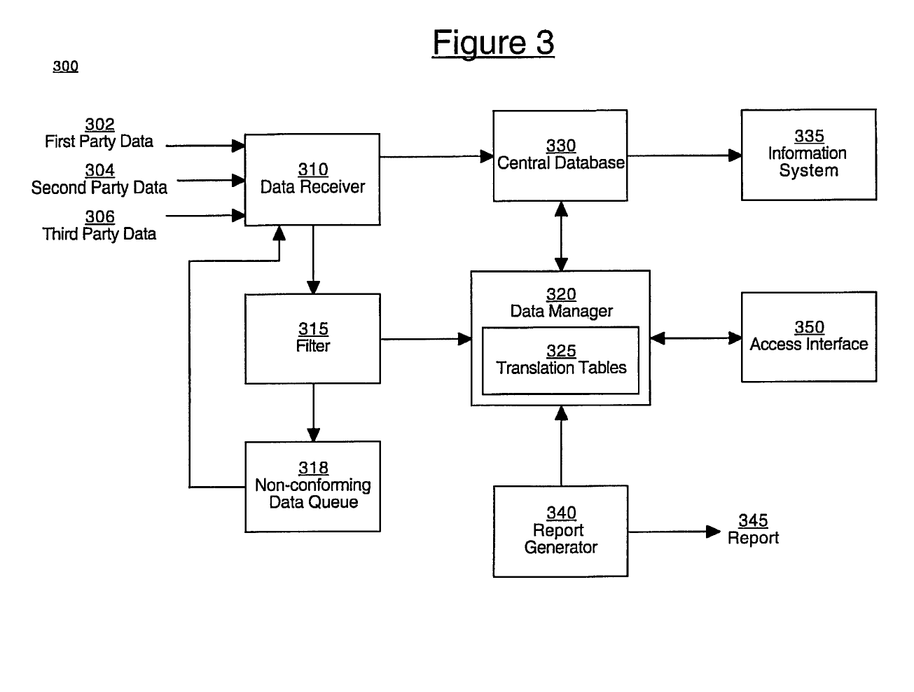

FIG. 3 illustrates a system 300 for managing a service agreement (also referred to herein as service agreement manager 300), in accordance with an embodiment of the present invention. System 300 includes data receiver 310, data manager 320, central database 330, report generator 340, and access interface 350. It should be appreciated that the components of system 300 may integrated into a single computing device (e.g., computer system 100 of FIG. 1) or may be distributed in part or in total among different computing devices over a computer network (e.g., distributed computer network 230 of FIG. 2). In various embodiments, data from customer database 330 maybe transmitted to the first party, second party, or third party information technology systems.

In one embodiment, system 300 may be integrated with other systems to provide an enterprise solution, such as an Enterprise Resource Planning (ERP) system. System 300 is operable to interact with multiple other systems either via Web Service APIs, Database APIs or Web Server URL redirects. In one embodiment, report generator 340 may output data to an ERP system. Accordingly, system 300 can then keep many other systems posted with the current status of the management of a service agreement using the above APIs. This enhances the ability of system 300 to work as integrated solutions for complex business processes requiring multiple parties to manage service agreements.

Data receiver 310 is operable to receive user input from multiple parties. In one embodiment, first party data 302 is received from a first party and second party data 304 is received from a second party. The first party and the second party are in a business relationship for providing service according to a service agreement to a customer. This business relationship may also be referred to as a business partnership. For example, the first party may be a device manufacturer that manufactures various electronic devices and the second party may be a device reseller that sells the electronic devices to an end user (e.g., customer). The third party data 306 acting as a distributor may also be an intermediary between the first party 302 and the second party 304. In conjunction with the sale of the electronic device, the second party sells service agreements on behalf of the first party.

In order to effectively manage the service agreements, each business partner provides information (first party data 302, second party data 304 and in come cases third party 306) to system 300. For example, where the first party is a device manufacturer, the first party data 302 may include, but is not limited to: a device serial number, device type, purchasing agent, end user or ship to name, second, second party purchase order number, list and net cost, contract type, addresses for first party second party and third party, first party sales representative name, current coverage status of device, contract type and coverage type, start data and end date of the contract, and other data fields as defined by Rossettanet Standards. Where the second party is a device reseller, the second party data 304 may include, but is not limited to: device serial number, service agreement terms, pricing, sales representative assignments, geographical placement information, customer identification, customer specific requirements, partner customer numbers industry sector information, customer contract information, data denoting if original second party reseller name, special pricing or contract terms provided by fist or third parties, time frames for special terms from first or third parties, co-termination dates of master contracts for the device, applicable rebates from first or third parties and associated terms.

In one embodiment, filter 315 is operable to filter first party data 302 and second party data 304 and third party 306, for data integrity. In order to efficiently provide management of service agreements, it is desirable to remove non-conforming data from the combined data pool. If a data item of the first party data or the second party data is not in conformance with the data integrity, the data item may be placed in a separate non-conforming data queue 318 apart from the combined data pool. It should be appreciated that data queue 318 may include multiple queues. By maintaining data integrity across the combined data pool by filtering out non-conforming data items, system 300 provides efficient management of service agreements. A user may access the data items of the non-conforming data queue 318 for review and correction of non-conformities. Once the data item is conforming with data integrity, the data item is forwarded to data receiver 310. It should be appreciated that filter 315 is optional.

In one embodiment, filter 315 is operable to determine whether a portion of a data item includes duplicate information with respect to a second data item. If the data item includes duplicate information with respect to a second data item, it is determined that the data item is non-conforming. For example, if the data item includes a duplicate serial number it is forwarded to the non-conforming data queue 318. In another embodiment, filter 315 is operable to determine whether a portion of the data item includes unrecognizable information. If the data item includes unrecognizable information, or that has been identified as non-confirming, it is determined that the data item is non-conforming. For example, if the customer identification is not recognized the data item is forwarded to non-conforming data queue 318.

Data manager 320 is operable to automatically integrate first party data 302 and second party data 304 to generate a combined data pool. The combined data pool includes all information provided by the first party, the second party and/or the third party. The combined data pool is stored in central database 330 and may be transmitted real-time to the first party, second party or third party data systems 335. In one embodiment, central database 330 includes historical data not typically maintained by the first party and the second party.

In one embodiment, translation table 325 of data manager 320 is used for transforming first party data 302 such that it is understandable to the second party and the customer and for transforming second party data 304 such that it is understandable to the first party and customer. For example, the customer identification of second party data 304 may include the name of a subsidiary of a larger company identified as the purchasing agent of the first party data 302. Another example would involve customer contract names for second party 304 or third party 306 that were previously unknown to the first party 302. The second party 304 or the third party 306 may also invoke a security feature that prevents the first party 302 from accessing some of all of the data elements that are unique and provided from the second party 304 and the third party 306. Translation table 325 is operable to transform the information such that all parties (e.g., first party, second party, and customer) can see the data appropriate data for their purposes. Continuing with this example, the second party can access information to facilitate improved management of service agreements by communicating directly with the purchasing agent and bypassing the subsidiary.

Moreover, the first party, the second party, or the third party may easily update translation table 325. For instance, in the event of an acquisition or a divestiture of a subsidiary, a link with the associated main company may be maintained, thus maintaining data integrity.

Report generator 340 is operable to generate a report in response to receiving a request for a report from the first party, the second party, the third party or the customer. The report is based on the request and the combined data pool, wherein the request identifies how data of the combined data pool is to be sorted. The report facilitates management of service agreements. For example, a device reseller may access system 300 and request a report sorted according to a geographic region, a sales representative, or a purchasing agent. Since system 300 has access to information provided by the device manufacturer as well as the device reseller, this report can be generated. In one embodiment, the report is output to a spreadsheet. In another embodiment, the report is output to an enterprise management system (e.g., an ERP). In another embodiment, the report is output as an email message to a party. In another embodiment, the customer may interact with data manager 320 directly through access interface 350.

Access interface 350 provides parties with access to system 300. In one embodiment, access interface 350 is accessible over an Internet connection, allowing the parties to access system 300 remotely. Using access interface 350, the first party, the second party, the third party, or the customer may request a report. It should be appreciated that the access may be limited such that certain information may be protected from certain parties. For example, a customer would not be able to access another customer's information nor any of the sensitive data such as the second party 204 or the third party 306 cost data from the first party 302.

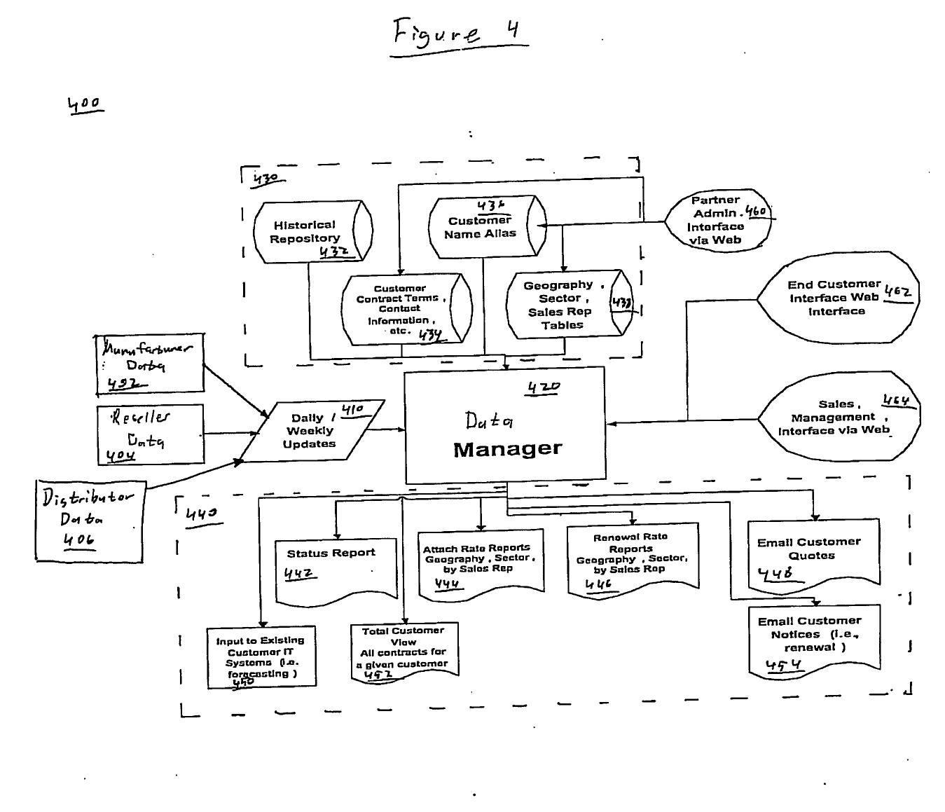

FIG. 4 illustrates a system 400 for managing a service agreement, in accordance with another embodiment of the present invention. System 400 is similar to system 300 as described above, but is specific to the device manufacturer/device reseller service agreement business. Manufacturer data 402 (e.g., first party data 302 of FIG. 3), reseller data 404 (e.g., second party data 304 of FIG. 3) are received on scheduled basis 410 (e.g., daily or weekly) at data manager 420. In one embodiment, distributor data 406 (e.g., third party data 306 of FIG. 3) is also received at data manager 420. It should be appreciated that although the following description includes references to distributor data 406, such references are exemplary and the receipt of distributor data 406 is optional.

Data manager 420 integrates manufacturer data 402, reseller data 404 and distributor data 406. In one embodiment, manufacturer data 402 and reseller data 404 are integrated with data located in central database 430. The data of central database 430 includes, but is not limited to: historical repository 432 for storing historical information, customer contract terms/contact information 434, customer name alias 436, and geography/sales representative information 438. In one embodiment, customer contract terms/contact information 434, customer name alias 436, and geography/sales representative information 438 are maintained by the device reseller (e.g., business partner) over a web-based interface 460. In the present embodiment, the customer contract terms/contact information 434, customer name alias 436, and geography/sales representative information 438 operate as a translation table used by data manager 420 to integrate manufacturer data 402 and reseller data 404. In one embodiment, data manager 420 filters out non-conforming data of manufacturer data 402 and reseller data 404, as described in FIG. 3.

Report generator 440 of system 400 is operable to generate a number of reports based on the manufacturer data 402, reseller data 404, and the information stored in central database 430. Report generator 440 may generate many different types of reports, including, but not limited to:
status reports 442;
attach rate reports 444;
renewal rate reports 446;
email customer quotes 448;
input to existing customer IT systems 450;
total customer view 452; and
email customer notices 454.

Web interface 460, 462 and 464 provide parties with access to system 400. In one embodiment, as described above, information stored in central database 430 used to create translation tables are maintained by the device reseller over web interface 460. In one embodiment, a customer can access system 400 to request a report over web interface 462. In another embodiment, the sales and/or management representatives of the reseller can access system 400 to request a report over web interface 464.

FIG. 5 is a flowchart diagram illustrating steps of a process 500 for managing a service agreement, in accordance with one embodiment of the present invention. In one embodiment, process 500 is carried out by processors and electrical components under the control of computer readable and computer executable instructions. Although specific steps are disclosed in process 500, such steps are exemplary. That is, the embodiments of the present invention are well suited to performing various other steps or variations of the steps recited in FIG. 5. In one embodiment, process 500 is executed by service agreement manager 300 of FIG. 3.

At step 510 of process 500, first data is received from a first party. At step 520, second data is received from a second party, wherein the first party and the second party are in a business relationship for providing service according to a service agreement to a customer. In one embodiment, the first party is a service provider for providing service to the customer according to the service agreement and the second party is a reseller of the service agreement for reselling the service agreement to the customer. In one embodiment, the service agreement comprises a contractual relationship between the customer and the first party such that the first party provides service on at least one electronic device used by the customer. In one embodiment, as shown at step 525, third data is received from a third party also in a business relationship with the first party and the second party. It should be appreciated that step 525 is optional.

In one embodiment, as shown at step 530, at least one of the first data and the second data is filtered for data integrity. If a data item of at least one of the first data and the second data is not in conformance with the data integrity, the data item is placed in a separate queue (e.g., non-conforming data queue 318 of FIG. 3) apart from the combined data pool, as shown at step 540. In one embodiment, it is determined whether a portion of the data item includes duplicate information with respect to a second data item such that if the data item includes duplicate information with respect to a second data item, it is determined that the data item is not in conformance with the data integrity. In one embodiment, it is determined whether a portion of the data item includes unrecognizable information such that if the data item includes unrecognizable information, it is determined that the data item is not in conformance with the data integrity. It should be appreciated that step 530 and 540 are optional.

At step 550, the first data and the second data are automatically integrated to generate a combined data pool that is understandable to both the first party and the second party. In one embodiment, as shown at step 552, the first data and the second data are compared to at least one translation table, wherein the translation table is for transforming the first data such that it is understandable to the second party and the customer and for transforming the second data such that it is understandable to the first party and the customer. At step 554, the first data and the second table are translated according to the translation table to generate the combined data pool.

In one embodiment, as shown at step 560, the combined data pool is automatically segmented into subsets of data based on predetermined categories. It should be appreciated that step 560 is optional. Segmenting the combined data pool provides improved report generation in that reports can be sorted according the categories of data. For example, the categories may include sales representative, geographical area, customer names, etc. The combined data pool is segmented into subsets according the various categories which may be identified in a request for a report.

At step 570, in response to receiving a request for a report from at least one of the first party, the second party and the customer, a report is generated based on the request and the combined data pool, wherein the request identifies how data of the combined data pool is sorted such that the report facilitates management of the service agreement. In one embodiment, the report is outputted to a spreadsheet. In another embodiment, the report is outputted to an enterprise management system. In another embodiment, the report is outputted as an email message to a party.

The described embodiments of the present invention provide a method and system for managing a service agreement business. For resellers to improve profitability of service agreements, it is important to proactively manage the sale and renewals of service agreements. The described embodiments provide for close to real-time management of service agreements by providing for the continuous receipt and integration of business party data. The received data is integrated, along with historical information, to provide resellers with timely information that is useful for managing a service agreement business. By integrating the information known to the manufacturer with information known to the reseller, all parties are provided with information not previously available, thus further improving management of a service agreement business.

Various embodiments of the present invention, a method and system for managing a service agreement business, are thus described. While the present invention has been described in particular embodiments, it should be appreciated that the present invention should not be construed as limited by such embodiments, but rather construed according to the below claims.

1. An article of manufacture including a non-transitory computer-readable medium having instructions stored thereon that, if executed by a computing device, cause the computing device to perform operations comprising:
receiving first data from an electronic device manufacturer, said first data including company names specified by the electronic device manufacturer, wherein the first data includes a first data object identifying a business entity by a particular one of the company names;
receiving second data from an electronic device reseller, said second data including aliases assigned by the electronic device reseller, wherein the second data includes a second data object for the same business entity, the second data object specifying one of the aliases instead of the particular company name;
wherein said electronic device manufacturer and said electronic device reseller are in a business relationship for providing service according to a service agreement to a customer;
maintaining a translation table that correlates the aliases to the company names;
accessing the translation table in response to receiving the first or second data to match the first and second data objects to each other and then integrating information from the matched objects into a same entry in a combined data pool; and
in response to receiving a request for a report from at least one of said electronic device manufacturer, said electronic device reseller and said customer, wherein the request identifies the particular company name or a correlated alias translation table generating said report based on said request and using said maintained translation table, said report including information from the same entry of the combined data pool.

2. The article of manufacture of claim 1, wherein the operations further comprise automatically segmenting said combined data pool into subsets of data based on predetermined categories.

3. The article of manufacture of claim 1, wherein the operations further comprise:
filtering at least one of said first data and said second data for data integrity; and
provided a first data item of at least one of said first data and said second data is not in conformance with said integrity, placing said first data item in a separate queue apart from said combined data pool.

4. The article of manufacture of claim 3, wherein said filtering comprises:
determining whether a portion of said first data item includes duplicate information with respect to a second data item; and
provided said first data item includes duplicate information with respect to said second data item, determining that said first data item is not in conformance with said data integrity.

5. The article of manufacture of claim 3, wherein said filtering comprises:
determining whether a portion of said first data item includes unrecognizable information; and
provided said first data item includes unrecognizable information, determining that said first data item is not in conformance with said data integrity.

6. (canceled)

7. The article of manufacture of claim 1, wherein said service electronic device manufacturer is a service provider for providing service to said customer according to said service agreement and wherein said electronic device reseller is a reseller of said service agreement for reselling said service agreement to said customer.

8. The article of manufacture of claim 1, wherein said service agreement comprises a contractual relationship between said customer and said electronic device manufacturer such that said electronic device manufacturer provides service on at least one electronic device used by said customer.

9. The article of manufacture of claim 1, wherein said report is outputted to a spreadsheet.

10. The article of manufacture of claim 1, wherein said report is outputted to an enterprise management system.

11. The article of manufacture of claim 1, wherein the operations further comprise:
receiving third data from a distributor, wherein said electronic device manufacturer, said electronic device reseller and said distributor are in a business relationship for providing service according to said service agreement to said customer; and
automatically integrating said third data into the combined data pool using the translation table.

12-21. (canceled)

22. A service agreement manager, comprising:
a processor and a memory storing instructions, the processor configured to execute the instructions to implement:
a data receiver for receiving first data from an electronic device manufacturer and for receiving second data from an electronic device reseller, wherein said electronic device manufacturer and said electronic device reseller are in a business relationship for providing service according to a service agreement to a customer;
wherein the first data includes company names specified by the electronic device manufacturer, and wherein the first data includes a first data object identifying one of the customers by a particular one of the company names;
wherein said second data includes aliases assigned by the electronic device reseller, and wherein the second data includes a second data object for the same customer, the second data object specifying one of the aliases instead of the particular company name;
a data manager configured to maintain a translation table that correlates respective ones of the aliases to represent ones of the company names;
the data manger configured to access the translation table in response to receiving the first data or the second data to match the first and second data objects to each other, the data manager configured to integrate information from the matched data objects into a same entry in a combined data pool; and
a report generator configured to generate a report in response to receiving a request for said report from at least one of said electronic device manufacturer, said electronic device reseller and said customer, wherein the request identifies the particular company name or a correlated alias from the translation table, said report based on said request and said maintained translation table, said report including information from the same entry of the combined data pool.

23. The service agreement manager as recited in claim 22, wherein said data manager is configurable to segment said combined data pool into subsets of data based on predetermined categories.

24. The service agreement manager as recited in claim 22, wherein said data manager comprises a filter configured to filter at least one of said first data and said second data for data integrity such that is a first data item of at least one of said first data and said second data is not in conformance with said data integrity, said first data item is placed in a separate queue apart from said combined data pool.

25. The service agreement manager as recited in claim 24, wherein said filter is configured to determine whether a portion of said first data item includes duplicate information with respect to a second data item such that if said first data item includes said duplicate information with respect to said second data item, it is determined that said first data item is not in conformance with said data integrity.

26. The service agreement manager as recited in claim 24, wherein said filter is configured to determine whether a portion of said first data item includes unrecognizable information such that if said first data item includes said unrecognizable information, it is determined that said first data item is not in conformance with said data integrity.

27. (canceled)

28. The service agreement manager as recited in claim 22, wherein said electronic device manufacturer is a service provider for providing service to said customer according to said service agreement and wherein said electronic device reseller is a reseller of said service agreement for reselling said service agreement to said customer.

29. The service agreement manager as recited in claim 22, wherein said service agreement comprises a contractual relationship between said customer and said electronic device manufacturer such that said electronic device manufacturer provides service on at least one electronic device used by said customer.

30. The service agreement manager as recited in claim 22, wherein said report generator outputs said report to a spreadsheet.

31. The service agreement manager as recited in claim 22, wherein said report generator outputs said report to an enterprise management system.

32. A system for managing a service agreement business, said system comprising:
means for receiving first data from an electronic device manufacturer and second data from an electronic device reseller, wherein said electronic device manufacturer and said electronic device reseller are in a business relationship for providing service according to a service agreement to a customer;
wherein the first data includes company names specified by the electronic device manufacturer, and wherein the first data includes a first data object identifying one of the customers by a particular one of the company names;
wherein said second data includes aliases assigned by the electronic device reseller, and wherein the second data includes a second data object for the same customer, the second data object specifying one of the aliases instead of the particular company name;
means for maintaining a translation table that correlates respective ones of the aliases to respective ones of the company names;
means for accessing the translation table in response to receiving the first data or the second data to match the first and second data objects to each other and integrating information from the matched data objects into a same entry in a combined data pool; and
means for generating a report based on a request for said report and said combined data pool in response to receiving said request from at least one of said electronic device manufacturer, said electronic device reseller and said customer, wherein the request identifies the particular company name or a correlated alias from the translation table, said report based on said report based on said request and said maintained translation table, said report including information from the same entry of the combined data pool.
